(19) United States
(12) Patent Application Publication
(10) Pub. No.: US 2023/0368798 A1
(43) Pub. Date: Nov. 16, 2023

(54) SECURE COMMUNICATION SYSTEM WITH SPEAKER RECOGNITION BY VOICE BIOMETRICS FOR USER GROUPS SUCH AS FAMILY GROUPS

(71) Applicant: KIWIP TECHNOLOGIES SAS, Bailly-Romainvilliers (FR)

(72) Inventors: Matthieu LIM, Torcy (FR); Ibtissam BRAHMI, Torcy (FR)

(21) Appl. No.: 18/044,247

(22) PCT Filed: Nov. 16, 2020
(86) PCT No.: PCT/EP2020/082208

§ 371 Date: Mar. 7, 2023

(30) Foreign Application Priority Data
Sep. 7, 2020 (FR) FR2009058

(51) Int. Cl. G10L 17/18; G10L 17/16; G10L 17/22; G10L 25/27; G10L 17/02

(52) U.S. Cl. CPC G10L 17/18; G10L 17/16; G10L 17/22; G10L 25/27; G10L 17/02

(57) ABSTRACT

The communication system (1) manages the communications of a plurality of user groups (GF) and authorizes secure communications between members (USER) of the same group (GF). The system comprises a server (SRC) and a plurality of user devices (UD) connected to an Internet-type network (IP) allowing voice communications. Speaker recognition and access authorization means (RL) are included and comprise artificial intelligence means (AI). According to the invention, the system comprises voice signal analysis means producing a scalogram of a speaker's voice signal by means of a discrete wavelet transform followed by a continuous wavelet transform, the scalogram being provided as input to the artificial intelligence means for speaker recognition.

The invention relates generally to the fields of communication via the Internet, the Internet of Things and artificial intelligence. More particularly, the invention relates to a communication system with speaker recognition by voice biometrics allowing the creation of a plurality of user groups, such as family groups, and secure communications between members of the same group. Because the invention has the ability to recognize the speaker, it also has applications in the authorization of the use of personalized services. Furthermore, in general, home automation, services, data science and the like may also benefit from the implementation of the invention.

The human vocal system can be compared to a non-linear system with constantly changing parameters, which poses a number of difficulties for speech recognition. Examination of a normal voice signal shows that it changes shape as the condition of the vocal tract changes. The human vocal system is thus a dynamic system which modifies the shape of the signal as a function of time. In addition, in the pronunciation of each phoneme, several transitions occur and modify the characteristics of the voice signal.

Speech recognition of children's voices faces increased challenges. This is because children have a shorter vocal tract and smaller vocal cords compared to adults. This leads to higher fundamental frequencies and formant frequencies, as well as significant spectral and temporal variabilities that complicate the recognition process and make it significantly less efficient. As a result, most of the known voice biometric recognition systems are trained and tested on adult voices. Furthermore, extracting the characteristics of the voice signal based on the so-called “MFCC” method, for “Mel-Frequency Cepstral Coefficients,” does not take into account the fundamental frequency of the signal, which strongly penalizes the quality of the recognition of children's voices.

It has been proposed to couple different information sources with the acoustic information coming from the vocal tract in order to improve the performance of speaker recognition. Thus, this recognition can be implemented according to different modalities, strongly linked to the use of linguistics, depending on the context, intonation and the like.

Various speaker recognition technologies using voice biometrics are commercially available, such as those offered by the companies Nuance®, Idemia® (OT-Morpho®) and Atos®, and are designed primarily to secure user payment transactions in connection with voice assistants. Technologies of this type are not able to deal with the subtleties that are present between the voices of people belonging to the same family.

Document US2010219936A1 proposes a technology using voice biometric signals and facial recognition to identify the name of an acquaintance, a family member or a newly met person, in order to save the user from an embarrassing moment in the event that he is unable to remember the person's name. The user is provided with a portable device that identifies the person through a speech recognition process. The recognized identity of the person is transmitted by an audio signal, via an earphone plug of the portable device, to the user's ear canal. The user triggers the identification of the person, for example by touching a unit which is inserted into his ear canal. After identification, the person's name is whispered into the user's ear canal. This technology does not use a predictive process and does not require learning from the circle of people encountered.

Document KR20190061732A describes a home system comprising wireless broadcasting terminals installed in homes of members of a family and having functions of motion detection, fire detection and reception of a biometric voice signal in a predetermined area. The terminal allows the reception and transmission of predetermined announcements from a main broadcasting device installed in a specific location, and the transmission of information to the main broadcasting device. This home system with speech recognition makes it possible to respond quickly to the occurrence of an emergency situation and controls a process for managing it.

CN107786397A discloses a security device for smart home care comprising a security device, a communication module connected to a plurality of household appliances, a detection module and a prompt module. The security device has a main control panel and is intended for home use. The main control panel is used to process information and is electrically connected to a camera module capable of identifying a target body. The detection module further includes a measurement module for detecting blood pressure data of the target body using microwaves, a biometric identification module for detecting physiological signals of the target body, and a module with wireless transmission for measuring water quality data that is assembled to water supply equipment of the dwelling. The device incorporates voice control and enables smart care for family members. In addition, gesture-based biometrics are used to order an adaptation of care to each member of the family.

The above prior art solutions proposed by US2010219936A1, KR20190061732A, CN107786397A allow biometric speech recognition in the service of daily family activities, but are unable to reliably identify a speaker's membership in a family group.

Moreover, other technologies are known in the state of the art and use artificial intelligence to improve biometric speech recognition.

Thus, a method is known from document KR20180065761A which uses a neural network to extract a genetic voice characteristic from the voice signal of a speaker. The genetic voice characteristic is used in a speech recognition model of the speaker. This method claims to improve the performance of speech recognition for children's voices.

Document U.S. Pat. No. 6,446,039B1 describes a speech recognition method and device integrating speaker learning. The device is used, for example, for voice control of an alarm, setting the time and the like. For speech recognition, speech model data of the speaker and speech model data of a group of speakers are used. Speaker-based adaptation can be achieved using subsequent speaker learning data. Identification of a speaker's membership in a group of speakers, such as a family group, is performed using a degree of similarity.

Document CN109726332A discloses a method and a system for creating personalized music lists based on self-learning, for different members of a family. The system stores sound information received from different family members and learns voiceprint characteristics of all family members. Family members with associated identifiers are recognized based on voiceprint characteristics. A personalized music database is generated for family members. The system performs self-learning on a large amount of data, such as songs on demand.

Document WO2019000991A1 relates to a neural network-based voiceprint recognition method and device designed to provide personalized service to multiple users using voice commands. The device is suitable for family use with multiple users who have different needs.

In general, the speech recognition technologies of the state of the art are based on a more or less defined number of voice characteristics or voice markers. However, within the same family, the voice characteristics are very close when more than 50% of the DNA is shared. These speech recognition technologies offer limited performance in discriminating against the voices of genetically related people, and even more if those voices are children's voices.

There is a need for a communication system dedicated to user groups, in particular family groups, that can guarantee a high level of security through the use of voice biometrics offering increased performance for speaker recognition. High-performance biometrics capable of discriminating children's voices is necessary for such a communication system dedicated to family groups, in order to secure access to the system and to family groups and to protect communications between children, their parents and/or their grandparents. The present invention aims to meet the above-mentioned need.

According to a first aspect, the invention relates to a communication system managing the communications of a plurality of user groups and authorizing secure communications between members of the same group, comprising a computer server and a plurality of user computing devices including mobile devices, the computer server and the plurality of user computing devices being connected to a wide area data communication network of the internet type allowing voice communications, the system also comprising speaker recognition means and access authorization including artificial intelligence means. According to the invention, the speaker recognition and access authorization means also comprise voice signal analysis means having cascaded first and second wavelet transform calculation modules producing a scalogram of a speaker voice signal by means of a discrete wavelet transform followed by a continuous wavelet transform, the scalogram being provided as input to the artificial intelligence means for the recognition of the speaker.

According to a particular feature, the first wavelet transform calculation module applies a mother wavelet called “Daubechies” wavelet to calculate the discrete wavelet transform.

According to another particular feature, the second wavelet transform calculation module applies a mother wavelet called “Haar” wavelet to calculate the continuous wavelet transform.

According to one particular embodiment, the artificial intelligence means comprise a convolutional neural network.

According to another particular embodiment, the artificial intelligence means comprise a probabilistic automaton of the “HMM” type.

According to yet another particular feature, the artificial intelligence means deliver, as output, access authorization verification information, speaker identification information and speaker membership group identification information.

According to yet another particular feature, the user computing devices include wearable smart devices and/or smartphones and/or tablets and/or computers.

According to yet another particular feature, the wearable smart devices include at least one connected watch and/or at least one smart watch.

According to yet another particular feature, said artificial intelligence means are partially or totally distributed in the user computing devices.

According to one particular embodiment of the system, the user groups are family groups and the artificial intelligence means are trained with a dataset bringing together voice recordings of members of different families grouped into family blocks of data, existing comparisons between the voices of siblings and between the voices of children and adults being accentuated, as well as the distance existing between the voices of children from different families.

According to another aspect, the invention also relates to a computer program comprising program code instructions implementing the communication system as briefly described above when these program code instructions are executed by a computing device processor.

The communication system according to the invention allows an optimal compromise between the constraints of processing speed, security and acoustic variability between users. In addition, an optimum intelligibility characteristic with respect to the environment surrounding the user has been sought, given the itinerant aspect of the mobile devices of the system and their use in potentially noisy environments.

Other advantages and features of the present invention will emerge more clearly on reading the description below of several particular embodiments with reference to the accompanying drawings, in which:

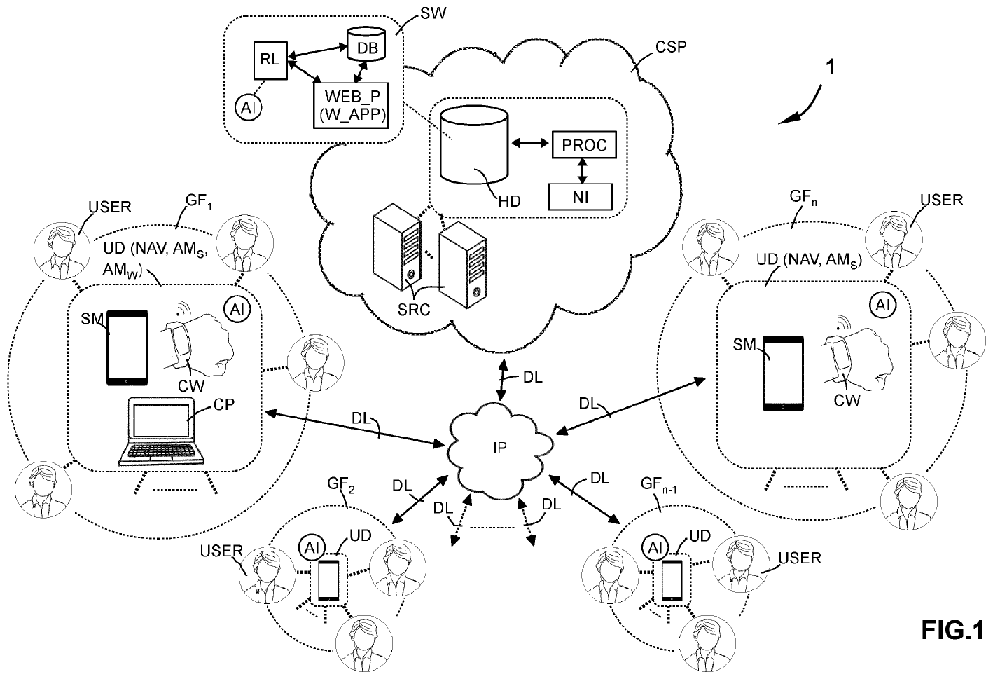

FIG. 1 schematically shows a secure communication system according to the invention having speaker recognition by voice biometrics and allowing the creation of a plurality of user groups, such as family groups.

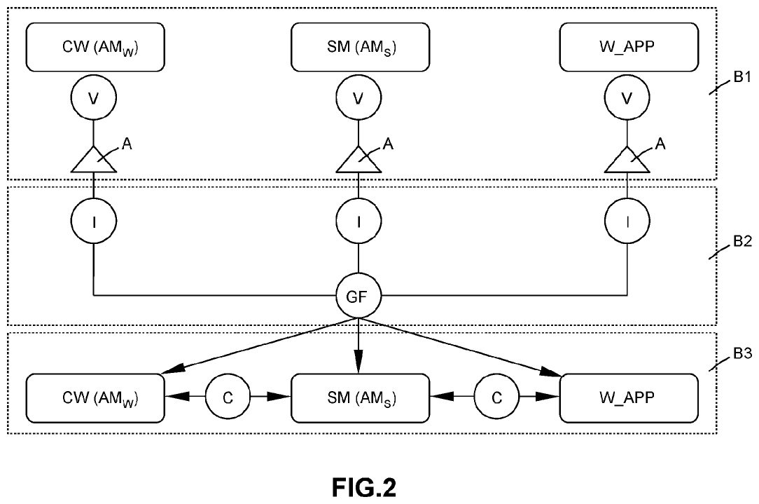

FIG. 2 is a diagram schematically showing the security arrangements integrated into a system according to the invention for access to system components, groups and communications.

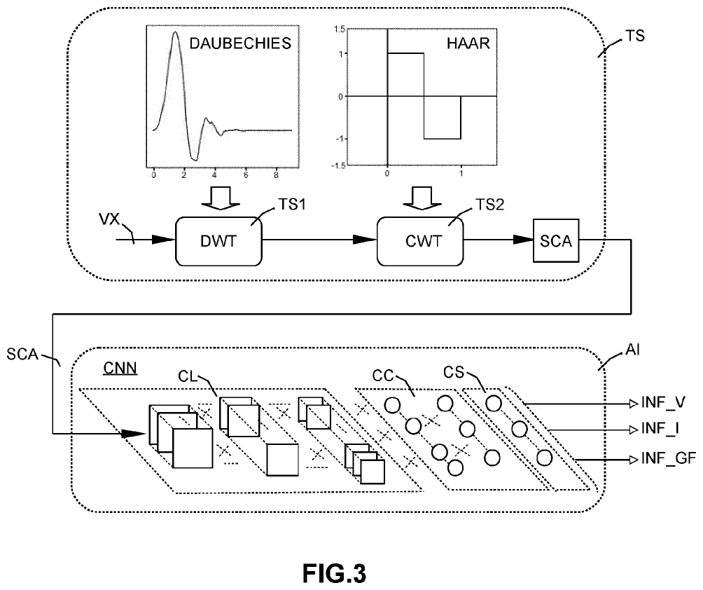

FIG. 3 is a basic block diagram schematically showing speaker recognition means integrated into a system according to the invention, in the form of a functional voice signal analysis block and of a convolutional neural network.

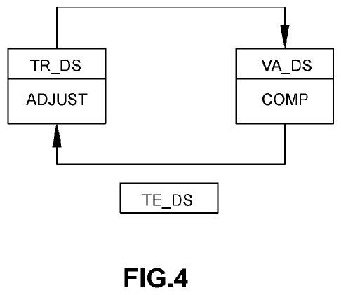

FIG. 4 is a block diagram illustrating a learning phase of the convolutional neural network of FIG. 3.

In the following description, for purposes of explanation and not limitingly, specific details are provided in order to facilitate understanding of the described technology. It will of course be apparent to those skilled in the art that other embodiments could be put into practice apart from the specific details described below. In other cases, detailed descriptions of well known techniques are omitted so as not to obscure the description with unnecessary detail.

In the communication systems of the invention, the recognition of the speaker is completely independent of the text spoken by the speaker and is based solely on the voice characteristics and signature of the voice, without dwelling on the content. The statistical nature of the voice signal is therefore of great importance during signal processing.

In the communication systems according to the invention, the communications between the users are essentially voice or video calls and the sending of multimedia messages or data. Thus, for example, the invention offers the possibility of connecting all of the members of a family in a “Wi-Fi” video call. Communications can also be established, in particular outside homes, through the cellular radiotelephone data communication network, for example of the “3G,” “4G” or “5G” type, including in “SOS” mode. Advantageously, a voice assistant can be integrated into the communication systems according to the invention to support users and to help them with any difficulties encountered on a daily basis.

With reference to FIGS. 1 to 4, there is now described below, by way of example, a particular embodiment 1 of a communication system according to the invention for secure intra-family communications between members of family groups.

With reference more particularly to FIG. 1, the communication system 1 according to the invention is deployed via a wide area data communication network IP, such as the internet network, and uses hardware and software resources that are accessible via this network. Thus, in this embodiment, the communication system 1 uses software and hardware resources available from a cloud service provider CSP.

The communication system 1 uses at least one computer server SRC from the cloud service provider CSP. The computer server SRC in particular comprises a processor PROC that communicates with a data storage device HD, which is typically dedicated to the communication system 1 and comprises one or more hard disks, and conventional hardware devices such as network interfaces NI and other devices (not shown). The processor PROC comprises one or more central data processing units (not shown) and volatile and non-volatile memories (not shown) for executing computer programs.

The communication system 1 comprises a software system SW which is hosted in the data storage device HD. The communication system 1 comprises several software modules that collaborate with each other, essentially including an internet software platform called “web platform,” designated WEB_P, necessary for the operation of a web software application, designated W_APP, of the system 1, a speaker recognition and access authorization software module RL, and a user database DB. The communication system 1 according to the invention is implemented in particular by the execution by the processor PROC of code instructions from the software system SW.

In general, in the communication system according to the invention, speaker recognition calls on an analysis of the voice signal and on artificial intelligence, hereinafter referred to as AI. The artificial intelligence AI can be centralized at the server SRC, more precisely in the speaker recognition and access authorization software module RL. However, it is often preferable for the artificial intelligence AI not to be centralized in the server SRC, but on the contrary to be distributed in the system, in particular in order to reduce the system response times during user access requests. In the embodiment described here by way of example, as shown schematically in FIG. 1, the artificial intelligence AI is implemented in the speaker recognition and access authorization software module RL and the user computing devices UD.

The communication system 1 manages the creation of a plurality of family groups, designated GF, by using its ability to recognize the voices of members of the same family. Thus, by way of example, FIG. 1 schematically shows several family groups GF₁, GF₂, . . . , GFₙ₋₁ and GFₙ which are active and the members of which, users of the system 1 designated USER, are in communication.

The users USER of the system 1 access the services of the communication system 1 through the internet network IP and communicate within their family group GF by means of their computing devices UD.

The computing devices UD typically include mobile devices of the users USER, such as a smartphone SM, a connected wearable device CW, and the like. The device CW, also referred to here as the wearable device CW, is typically, but not exclusively, a connected watch operating with the smartphone SM or a smart watch comprising its own “SIM” card, for “Subscriber Identity Module.” The computing devices UD also include tablets and computers CP of the users USER.

The computing devices UD access the internet network IP and the computer server SRC through data communication links DL, typically either through a cellular radiotelephone data communication network, for example of the “3G,” “4G” or “5G” type, or through a local data communication network of the “Wi-Fi” type.

The user USER can access the communication system 1 through the web platform WEB_P open in an internet browser of their computing device UD, typically a smartphone SM, a tablet or a computer CP. The user USER can also access the functionalities of the communication system 1 through a dedicated mobile software application AM_{S} typically installed on their smartphone SM, or their tablet CP. When the wearable device CW, for example a smart watch, has the required capacity, another dedicated mobile software application AM_{W} can be installed there and will allow the user USER to access the functionalities of the system 1. The mobile software applications AM_{S}, AM_{W} each have a user interface adapted to the device UD and are in communication with the software system SW. Moreover, in certain applications of the invention, the software system SW may also include a programming interface, called “API,” for “Application Programming Interface,” that is accessible by the mobile software applications of the system 1 or by other systems cooperating with the system 1, such as a home automation system or the like, for example.

In the communication system 1 according to the invention, several arrangements make it possible to guarantee high security of communications and of access to members and family groups. The users USER of the system 1 can thus remain in continuous contact without risk. This high security is obtained mainly through the following four provisions:

1) When establishing a communication, the offer is exchanged according to the “HTTPS” protocol for “HyperText Transfer Protocol Secure.” This arrangement guarantees an encrypted connection between the server SRC, hosting the web application W_APP, and the internet browser NAV, the mobile application AM or the wearable device CW. When the connection is established, the data is exchanged using the “DTLS” protocol, for “Datagram Transport Layer Security,” and the “SRTP” protocol, for “Secure Real-Time Protocol,” more specifically for audio and video data. These “DTLS” and “SRTP” protocols, available in so-called “WebRTC” telecommunications technology, guarantee the confidentiality of communications by offering real-time encryption of data. “WebRTC” technology is a proven standard available in the majority of internet browsers and which offers the advantage of not requiring the installation of an extension software module, known as a “plug-in.” The “WebRTC” technology can thus be used advantageously, in particular in the connection between the wearable device CW and the Web application W_APP, to prevent any listening and falsification of the information which passes between them.

2) Logic filtering, described in more detail below with reference to FIG. 2, which is carried out essentially at the server SRC, by the speaker recognition and access authorization software module RL of the software system SW, to only allow the linking of authorized members of the same family group.

3) The use of data-type SIM cards, called “data SIM cards,” which provide users USER with identifiers different from the usual telephone numbers. These identifiers other than phone numbers reduce the likelihood of users USER being targeted by scams such as “Ping Call” and others.

4) The biometric speech recognition installed in the communication system according to the invention processes voice signals in the frequency band of 20 Hz-20 kHz. This feature provides immunity against voice signals from recordings emitted by an electroacoustic transducer or telephone speaker, which could be used by malicious parties seeking to unlock the system. Indeed, these voice signals are emitted with a smaller frequency band and are rejected by the biometric speech recognition of the system.

In the system 1, access to the various components, namely the web application W_APP, the mobile software application AM_{S} and the wearable device CW, is conditioned on the recognition of the members of the family group, each member in the session that was created for it by a group administrator. The group administrator is responsible for the family group and has the necessary rights to configure and set up the system 1 for his family group.

Referring now also to FIG. 2, in the communication system 1, the speaker recognition fulfills not only the conventional known functions of speaker identification and speaker verification, but also a function of identifying the group to which the speaker belongs directly from said speaker's voice. The means integrated into the invention, which will be detailed below in the description, allow fine recognition of the speaker and are able to take care of the subtleties of children's voices and their variability. This fine recognition also enables the reliable recognition of a group administrator member or of several administrator members forming an administrator subgroup managing the system for a larger group, for example, an administrator family core within an extended family also including grandparents, aunts, uncles, cousins, etc.

Functional blocks B1, B2 and B3 are shown in FIG. 2.

Block B1 concerns the verification functions V executed in the event that the user USER wishes to either unlock access to a component of the system 1, such as the web application W_APP, the mobile software application AM_{S} or the wearable device CW shown in FIG. 2, or to unlock access to an option that requires authorization from the group administrator.

Block B2 concerns the identification I and family group GF functions. Access to the restricted functionalities of the system 1 is conditioned on the recognition of the speaker whatever the usage case, namely, an unlocking, a configuration or an access, or action, requiring a permission from the group administrator to whom a request is sent. The access, or action, is only authorized if the speaker's voice is recognized as one of the voices belonging to the family group GF concerned. Thus, if the user USER is identified and authorized, said user can have access to the configuration of sensitive hardware parameters, for example, parameters relating to communications, settings, wearable device status, etc., through the web application or mobile application. The family groups GF are created by classifying the different incoming voices by a genetic comparison of the voice characteristics. The identification function I by speaker recognition is also executed when the user USER wishes to access the information of the members of the family group GF.

Block B3 concerns communication functions C. Communications can only take place between members of the same family group. Communications between users USER are voice or video calls and sending messages or multimedia data. The communications are established through the components of the system 1 that have been unlocked, such as the web application W_APP, the mobile software application AM_{S} or the wearable device CW shown in FIG. 2.

With more particular reference to FIGS. 3 and 4, now described below, through a particular embodiment, is the architecture and operation of the speaker recognition and access authorization software module RL integrated into a communication system according to the invention and the implementation of the artificial intelligence functions in the system 1.

As can be seen in FIG. 3, the speaker recognition and access authorization software module RL essentially comprises two functional blocks, namely, a voice signal analysis functional block TS and an artificial intelligence module AI.

In this particular embodiment, the artificial intelligence module AI takes the form of a Convolutional Neural Network, called “CNN.” The convolutional neural network CNN is capable of deep training, or deep learning. The convolutional neural network CNN could, for example, be developed using the TensorFlow® library, known to those skilled in the art as being an open source software library, developed by the company Google®.

In the module RL, the speaker recognition is achieved by using an extraction of voice characteristics based on the wavelet transform in the functional block TS and the artificial intelligence provided here by the neural network CNN.

The functional block TS is responsible for processing a voice signal VX supplied as an input to extract important voice characteristics and information therefrom which can be used for speaker recognition. The voice signal VX comes from the microphone of a device UD such as a wearable device CW, a smartphone SM, a tablet or a computer CP. The functional block TS provides, as output, a scalogram SCA representative of the voice signal VX and usable by the neural network CNN.

According to the invention, the process performed by the voice signal analysis functional block TS processes the voice signal VX in particular by means of two successive wavelet transforms respectively calculated by wavelet transform calculation modules TS1 and TS2.

In general, the wavelet transform decomposes the signal into a plurality of coefficients that are associated with a family of wavelets. The wavelet family is obtained from a single mother wavelet by dilations and temporal shifts. The wavelet transform allows scanning of the frequency spectrum with a variable window. This transform offers high frequency and temporal resolution and improves the analysis of the signal, compared for example with a Fourier transform. The wavelet transform is well suited to the analysis of children's voice signals, which are characterized by very frequent intraspeaker variability.

The wavelet transform calculation module TS1 applies a Discrete Wavelet Transform, called “DWT,” which is centered around the analysis of the voice signal VX using different time and frequency scales, and taking into account the low and high frequencies. The discrete wavelet transform “DWT” provides coefficients that represent the signal VX sparingly, keeping only the important and useful information of the signal VX. The signal VX is thus denoised, which is necessary in view of the critical use cases of the system 1, in an external environment, where the signal/noise ratio thereof is degraded.

The wavelet transform calculation module TS2 applies a Continuous Wavelet Transform, called “CWT,” to the output supplied by the wavelet transform calculation module TS1. The wavelet transform calculation module TS2 outputs all of the relevant characteristics of the voice signal VX in the form of an image represented by the scalogram SCA. The scalogram SCA is provided for use by the neural network CNN in order to recognize the speaker and identify the group to which he belongs.

Regarding the “DWT” and “CWT” wavelet transforms applied to extract the characteristics of the voice signal VX, calculations, simulations and tests carried out by the inventive entity have shown that the choice of the mother wavelet used to make translations and dilations and to form the wavelet family basis is essential for the reliability and performance of speaker recognition.

The choice of the optimal mother wavelet is based on the exploitation of two main concepts which are energy, within the framework of a qualitative approach, and entropy, within the framework of a quantitative approach. The energy indicates the similarity between the incoming voice signal and the considered mother wavelet. Entropy indicates a level of missing information between the incoming voice signal and the considered mother wavelet.

The obtained results on energy and entropy depend closely on the characteristics of the mother wavelet. The characteristics generally taken into consideration are those of orthogonality, compactness of the support, symmetry and vanishing moment.

The optimal mother wavelet is the one offering the best compromise between energy maximization and entropy minimization. The so-called Shannon entropy was used and imposes respect for the equation L≥2p−1, L being the size of the support and p the number of zero moments.

The calculations, simulations and tests carried out by the inventive entity took into account different mother wavelets, including the so-called “Daubechies,” “Symlets,” “Coiflets,” “Biorthogonal,” “Reverse Biorthogonal,” “Discrete Meyer,” “Mexican hat,” “Morlet,” “Gaussian,” “Complex Gaussian” and “Haar.” The choice of the “Daubechies” wavelet for the discrete wavelet transform and of the Haar wavelet for the continuous wavelet transform proved to be the optimal choice offering the best compromise. This choice is validated by the stochastic gradient descent method, by calculating derivatives of the resulting wavelet equations in order to minimize entropy while maximizing energy.

The convolutional neural network CNN provides an artificial intelligence function which is pre-trained to recognize the speaker from the scalogram SCA of his voice supplied as an input and to deliver output information items INF_V, INF_I and INF_GF representative of the result of the recognition. The output information items INF_V, INF_I and INF_GF are the outputs supplied by the speaker recognition and access authorization software module RL and which can be used by the functional management of the system 1. The information INF_V concerns the verification and indicates the rejection or acceptance of the speaker as user USER of the system 1. The information INF_I concerns the identification and indicates the identity of the recognized speaker. The information INF_GF indicates the group to which the recognized speaker belongs.

The architecture and operation of a convolutional neural network will not be described here in detail, these being known to those skilled in the art and widely documented in the literature. Briefly, in the convolutional neural network CNN, the scalogram SCA is first processed by a number of convolutional layers CL which ensure the extraction of the voice characteristics that are present in the scalogram SCA. Classification layers CC of the convolutional neural network CNN provide classification and prioritization of the extracted features. In a known manner, the convolutional neural network CNN carries out a repetitive process of convolutional filtering, batch normalization, and pooling and max pooling, until obtaining a fully connected dense layer. Activation functions provide probabilities to the neurons of output layers CS for obtaining the verification INF_V, identification INF_I and family group INF_GF outputs. For example, an activation function called “Sigmoid” could be chosen for the verification output INF_V and an activation function called “Softmax” could be chosen for the identification INF_I and family group INF_GF outputs.

Thus, in an output layer CS, the number of neurons represents the number of classes. In the case of an identification, for a certain family group, the number of classes in the output layer CS concerned is the number of candidate members to present themselves to the system 1 and among which we will identify the speaker facing the system 1. Each output neuron provides the probability that a member is the speaker. The convolutional neural network CNN predicts the member with the highest probability as the speaker. In the case of verification, a binary classification is performed. The relevant output layer CS includes a single neuron that provides the probability that the person attempting to unlock the system matches the user authorized to do so, with an acceptance threshold. In the case of family group identification, the number of neurons in the relevant output layer CS is the number of family groups that use system 1. Each neuron corresponds to a family group and provides the probability that the speaker is a member of the family group.

The learning phase of the convolutional neural network CNN is now described below with reference more particularly to FIG. 4.

The convolutional neural network CNN is trained with distinct datasets, depending on the usage case, that is to say, depending on whether it involves verification, speaker identification or family group identification.

Thus, in this embodiment of the communication system according to the invention, a first dataset is the Voxceleb® dataset from Creative Commons®, which is used for training the verification INF_V and identification INF_I outputs of the speaker. The Voxceleb® dataset contains voice samples from over 7,000 people of different origins, professions and ages, with different accents, and provides over one million voice samples representing approximately two thousand hours of recording, with voice samples having lengths of 3 to 20 seconds each.

A second dataset was created specifically for the training of the identification output INF_GF of the family group. This second dataset was obtained by bringing together voice recordings of members of different families and grouping them into family blocks of data. The connections that exist between the voices of siblings and between the voices of children and adults are accentuated, as well as the distance that exists between the voices of children from two different families. New data were synthesized from those available in order to enrich this second dataset. These new data were obtained by introducing noise, introducing random time shifts, changing volume, changing playback speed and other techniques.

The first and second datasets were each partitioned into three groups to form training TR_DS, validation VA_DS, and test datasets TE_DS, in proportions of 70% for training, 15% for validation, and 15% for testing.

The learning phase is shown schematically in FIG. 4.

The convolutional neural network CNN is trained for each use case, namely, verification, speaker identification and family group identification, using the training dataset TR_DS, the validation dataset VA_DS and test dataset TE_DS. The data fed into the convolutional neural network are formed from scalograms SCA from the voice recordings. During this learning phase, the convolutional neural network CNN is trained on the data with an objective of minimizing a loss function.

Training is performed using the training dataset TR_DS and the validation dataset VA_DS. The correct outputs INF_V, INF_I and INF_GF associated with the data SCA are provided during learning. The network AI is trained with the set TR_DS, with adjustments ADJUST to the model weights and biases. The validation dataset VA_DS is used to assess the overfitting of the neural model, by a comparison COMP of the respective loss functions of the two datasets TR_DS and VA_DS.

The test dataset TE_DS does not include the correct outputs INF_V, INF_I and INF_GF and is used to evaluate the final neural model which is obtained by convergence of the learning algorithm.

The obtained final neural model is saved and converted for implementation in the communication system. As indicated above in the description, the artificial intelligence AI is preferably distributed in the system. Thus, the final neural model can be implemented in wearable devices CW, smartphones SM and internet browsers NAV of devices UD in order to optimize response times. The final neural model can thus be converted into a JavaScript® version that can be executed in a internet browser NAV. The TensorFlow Lite® tool library can be used to convert the final neural model into a version that can be run on mobile devices like CW and SM.

In addition, it will be noted that in certain embodiments, it is all of the functions described above of the speaker recognition and access authorization software module RL, namely, the analysis of the voice signal provided by the modules TS1, TS2, and the artificial intelligence AI provided by the neural network CNN, which can be distributed in the system and implemented in wearable devices CW, smartphones SM and internet browsers NAV of devices UD.

In the embodiment of the invention described more particularly here with the system 1, the artificial intelligence has been obtained by means of the convolutional neural network CNN. Other artificial intelligence solutions may be chosen in other embodiments of the invention. Thus, the artificial intelligence could be provided by a probabilistic automaton of the type called HMM, for “Hidden Markov Model,” authorizing a tri-modal recognition of the speaker and delivering the verification INF_V, identification INF_I and family group INF_GF outputs.

In general, the communication systems according to the invention are not limited to family groups whose members all have genetic markers in common. The communication systems according to the invention can also be designed to meet the needs of blended families and adopted children, as well as the needs of groups of people who are not linked by family ties. This will be achieved by pre-recording the voice signatures of the concerned people.

The case of a change in the voice, for example, due to a physiological or pathological factor, such as breaking of the voice or a sore throat, is taken into account in the communication system according to the invention and is handled owing to an auxiliary authentication mode to which users have access in order to, if necessary, reconfigure the system with the modified or new voice.

The invention finds a preferred application in the family context, in particular to allow children to stay in secure and continuous contact with their family. However, of course, the invention could find many other applications with specific objects and services intended for typical usage cases, for example, for seniors, but also for animals and the like.

Furthermore, the security of access to the communication system according to the invention may be reinforced in certain applications by bimodal recognition, for example by associating verification by facial biometrics with verification by voice biometrics. In addition, in other applications, the communication system according to the invention could be designed to unlock only in the presence of two speakers, typically an adult and his child.

Insofar as the mobile devices used in the communication system according to the invention have the “NFC” function, for “Near Field Contact,” the biometric speech recognition provided by the system can be used for payment, access validation for public transport, opening a lock, a home automation function and the like.

In certain applications, the communication system according to the invention may be interfaced with systems of partner organizations, with easy access owing to the authentication provided by the biometric speech recognition. Family data can be centralized in a single storage unit, called a “hub”, and be made accessible to these partner organizations, such as schools, nursing homes or retirement homes, hotels, payment, reservation, transport, purchasing and other service providers, so as to benefit from appropriate and secure tailor-made services.

Of course, the invention is not limited to the embodiments which have been described here by way of illustration. Those skilled in the art, depending on the applications of the invention, may make various modifications and variants falling within the scope of protection of the invention.

1. Communication system managing the communications of a plurality of user groups and authorizing secure communications between members of the same group (GF), comprising a computer server and a plurality of user computing devices including mobile devices, said computer server and said plurality of user computing devices being connected to a wide area data communication network (IP) of the internet type allowing voice communications, said system also comprising speaker recognition means including artificial intelligence means, characterized in that said speaker recognition and access authorization means also comprise voice signal analysis means having cascaded first and second wavelet transform calculation modules producing a scalogram of a speaker voice signal by means of a discrete wavelet transform followed by a continuous wavelet transform, said scalogram being inputted to said artificial intelligence means for the recognition of the speaker.

2. Communication system according to claim 1, characterized in that said first wavelet transform calculation module applies a mother wavelet called “Daubechies” wavelet to calculate the discrete wavelet transform.

3. The communication system according to claim 1, characterized in that said second wavelet transform calculation module applies a mother wavelet called “Haar” wavelet to calculate the continuous wavelet transform.

4. Communication system according to claim 1, characterized in that the artificial intelligence means comprise a convolutional neural network.

5. Communication system according to claim 1, characterized in that said artificial intelligence means comprise a probabilistic automaton of the “HMM” type.

6. Communication system according to claim 1, characterized in that the artificial intelligence means deliver, as output, access authorization verification information, speaker identification information and speaker membership group identification information.

7. Communication system according to claim 1, characterized in that the user computing devices include wearable smart devices and/or smartphones and/or tablets and/or computers.

8. Communication system according to claim 7, characterized in that said wearable smart devices include at least one connected watch and/or at least one smart watch.

9. Communication system according to claim 1, characterized in that said artificial intelligence means partially or totally distributed in the user computing devices.

10. Communication system according to claim 1, wherein said user groups are family groups, characterized in that said artificial intelligence means are trained with a dataset bringing together voice recordings of members of different families grouped into family blocks of data, existing comparisons between the voices of siblings and between the voices of children and adults being accentuated, as well as the distance existing between the voices of children from different families.
